(19) United States
(12) Patent Application Publication
(10) Pub. No.: US 2017/0217205 A1
(43) Pub. Date: Aug. 3, 2017

(54) THERMAL HEAD AND THERMAL PRINTER

(71) Applicant: KYOCERA Corporation, Kyoto-shi, Kyoto (JP)

(72) Inventors: Yuuna OOKUBO, Kirishima -shi (JP); Yoichi MOTO, Okaya -shi (JP); Yui TANAKA, Muko -shi (JP)

(73) Assignee: KYOCERA Corporation, Kyoto-shi, Kyoto (JP)

(21) Appl. No.: 15/329,751

(22) PCT Filed: Jul. 29, 2015
(86) PCT No.: PCT/JP2015/071514

§ 371 Date: Jan. 27, 2017

(30) Foreign Application Priority Data
Jul. 29, 2014 (JP) 2014-153947

(51) Int. Cl. B41J 2/355

(52) U.S. Cl. CPC B41J 2/355

(57) ABSTRACT

[Object] To provide a thermal head with which a substrate is not likely to become broken.

[Solution] A thermal head X1 includes a substrate 7 having a first main surface 7f and an end surface 7e adjacent to the first main surface 7f; a plurality of heating elements 9 disposed on the first main surface 7f or on the end surface 7e; a plurality of electrodes disposed on the first main surface 7f and electrically connected to the plurality of heating elements 9; a first covering layer 27a disposed on parts of the plurality of electrodes; a connector 31 disposed adjacent to the end surface 7e and including a plurality of connector pins 8 disposed on the plurality of electrodes and a housing 10 containing the plurality of connector pins 8; and a covering member 12 covering the plurality of connector pins 8 on the plurality of electrodes together with the plurality of electrodes. The thermal head further includes a second covering layer 27b extending from the first covering layer 27a onto the end surface 7e. The housing 10 is in contact with the second covering layer 27b. Thus, the probability of breakage of the substrate 7 can be reduced.

### TECHNICAL FIELD

The present invention relates to a thermal head and a thermal printer.

### BACKGROUND ART

To date, various thermal heads have been developed as a printing device for a facsimile, a video printer, or the like. For example, a known thermal head includes a substrate having a first main surface and an end surface adjacent to the first main surface; a plurality of heating elements disposed on the first main surface or on the end surface; a plurality of electrodes disposed on the first main surface and electrically connected to the plurality of heating elements; and a connector including a plurality of connector pins disposed on the plurality of electrodes and a housing containing the plurality of connector pins, the connector being disposed adjacent to the end surface.

In the thermal head, the connector pins hold an edge portion of the substrate between the connector pins, and thereby the electrodes and the connector pins are electrically connected to each other and the connector is attached to the substrate. To improve electrical insulation or joint strength, the thermal head includes a covering member that covers the plurality of connector pins on the plurality of electrodes together with the plurality of electrodes (see PTL 1).

### CITATION LIST

### Patent Literature

PTL 1: Japanese Unexamined Patent Application Publication No. 2000-173695

### SUMMARY OF INVENTION

### Technical Problem

However, when inserting the substrate into the connector, the substrate may contact the connector pins and may break.

### Solution to Problem

A thermal head according to an embodiment of the present invention includes a substrate having a first main surface and an end surface adjacent to the first main surface; a plurality of heating elements disposed on the first main surface or on the end surface; a plurality of electrodes disposed on the first main surface and electrically connected to the plurality of heating elements; a first covering layer disposed on parts of the plurality of electrodes; a connector disposed adjacent to the end surface and including a plurality of connector pins disposed on the plurality of electrodes and a housing containing the plurality of connector pins; and a covering member covering the plurality of connector pins on the plurality of electrodes together with the plurality of electrodes. The thermal head further includes a second covering layer extending from the first covering layer onto the end surface. The housing is in contact with the second covering layer.

A thermal printer according to an embodiment of the present invention includes the thermal head; a transport mechanism that transports a recording medium onto the heating elements; and a platen roller that presses the recording medium against the heating elements.

### Advantageous Effects of Invention

With the present invention, the probability of breakage of the substrate can be reduced.

### BRIEF DESCRIPTION OF DRAWINGS

FIG. 1 is a plan view of a thermal head according to a first embodiment.

FIG. 2 is a sectional view taken along line I-I shown in FIG. 1.

FIG. 3 illustrates a connector of the thermal head according to the first embodiment, part (a) is a perspective view, and part (b) is a partial enlarged perspective view.

FIG. 4 illustrates the connector of the thermal head according to the first embodiment, part (a) is a perspective view of a connector pin of the connector, part (b) is a front view, and part (c) is a rear view.

FIG. 5 shows enlarged views of a region near the connector of the thermal head according to the first embodiment, part (a) is a plan view, and part (b) is a bottom view.

FIG. 6 part (a) is a sectional view taken along line II-II shown in FIG. 5(a), and part (b) is a sectional view taken along line III-III shown in FIG. 5(a).

FIG. 7 is a schematic view of a thermal printer according to the first embodiment.

FIG. 8 is a schematic partial perspective view of a head base body of a thermal head according to a second embodiment.

FIG. 9 illustrates the thermal head according to the second embodiment, part (a) is a sectional view corresponding to FIG. 6(a), and part (b) is a sectional view corresponding to FIG. 6(b).

FIG. 10 is a schematic partial perspective view of a head base body of a thermal head according to a third embodiment.

FIG. 11 shows enlarged views of a region near a connector of the thermal head according to the third embodiment, part (a) is a plan view, and part (b) is a bottom view.

FIG. 12 part (a) is a sectional view taken along line IV-IV shown in FIG. 11(a), and part (b) is a sectional view taken along line V-V shown in FIG. 11(a).

FIG. 13 illustrates a thermal head according to a fourth embodiment, part (a) is a sectional view corresponding to FIG. 6(a), and part (b) is a sectional view corresponding to FIG. 6(b).

FIG. 14 illustrates a thermal head according to a fifth embodiment, part (a) is a sectional view corresponding to FIG. 6(a), and part (b) is a sectional view corresponding to FIG. 6(b).

### DESCRIPTION OF EMBODIMENTS

### First Embodiment

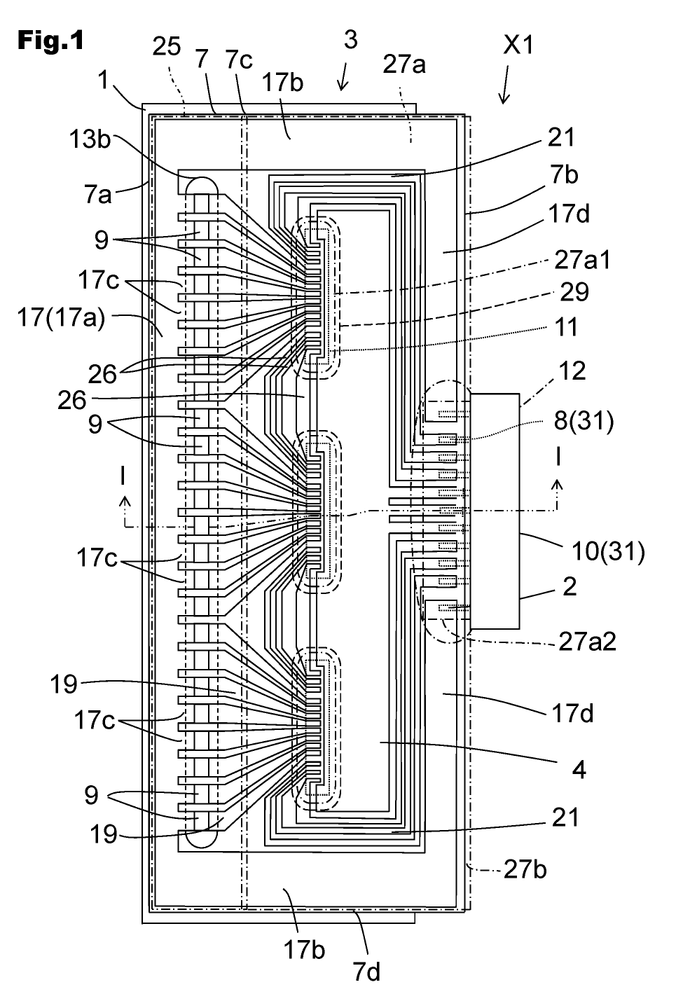

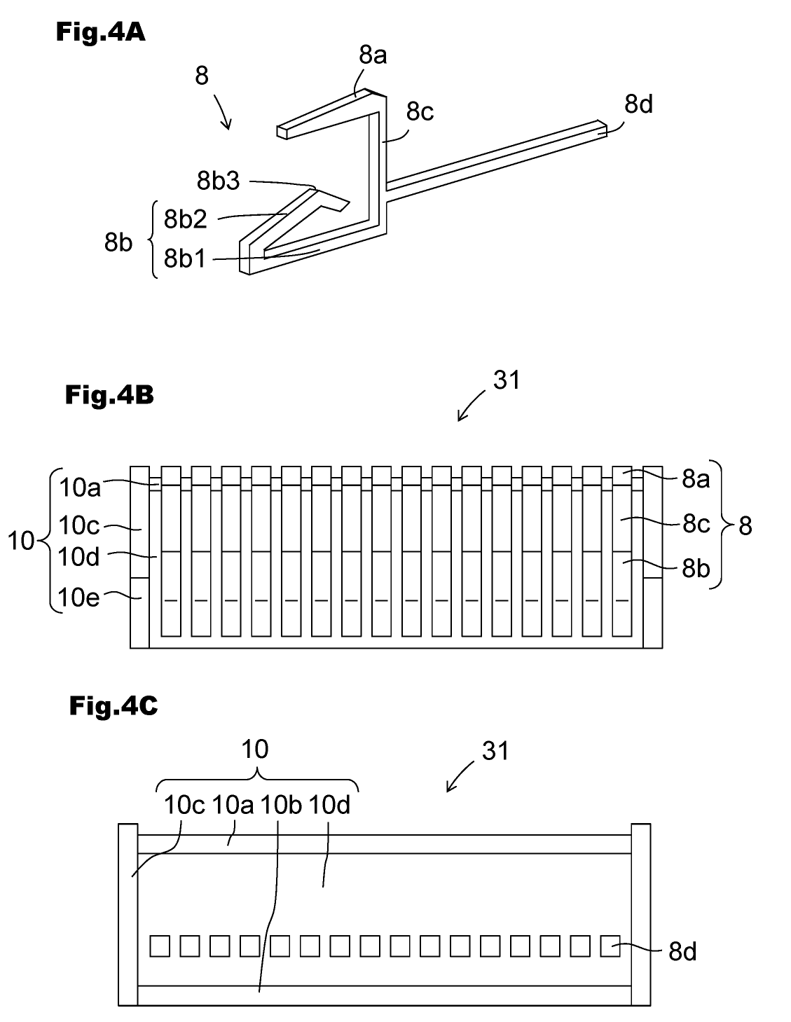

Hereinafter, a thermal head X1 will be described with reference to FIGS. 1 to 6. In FIG. 1, a protective layer 25, a covering layer 27, and a covering member 12 are omitted and shown by alternate long and short dash lines. In FIG. 1, the shape of the covering member 12 is simplified.

The thermal head X1 includes a heat sink 1, a head base body 3 disposed on the heat sink 1, and a connector 31 connected to the head base body 3.
i. The heat sink 1 is rectangular-parallelepiped-shaped. The heat sink 1 is made of, for example, a metal material, such as copper, iron, or aluminum. The heat sink 1 has a function of dissipating a part of heat that is generated by heating elements 9 of the head base body 3 and that does not contribute to printing. The head base body 3 is affixed to the upper surface of the heat sink 1 by using double-sided tape, an adhesive, or the like (not shown).

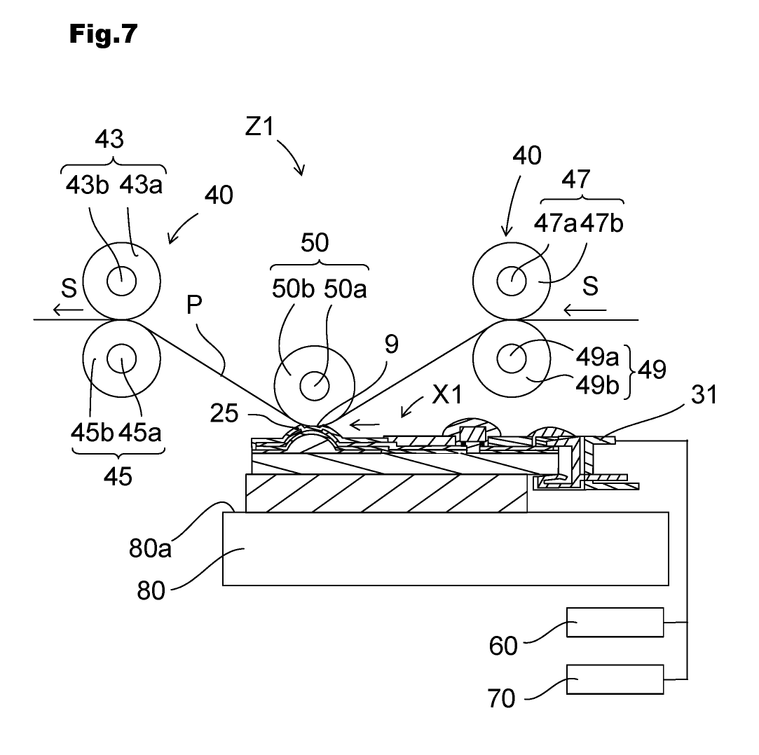

The head base body 3 is rectangular in plan view. Components of the thermal head X1 are disposed on a substrate 7 of the head base body 3. The head base body 3 has a function of performing printing on a recording medium P (see FIG. 7) in accordance with an electric signal supplied from the outside.

The connector 31 includes a plurality of connector pins 8 and a housing 10 that contains the plurality of connector pins 8. One part of each of the plurality of connector pins 8 is exposed to the outside of the housing 10, and the other part of each of the plurality of connector pins 8 is contained in the housing 10. The plurality of connector pins 8 have a function of electrically connecting various electrodes of the head base body 3 to a power source, which is disposed outside. The plurality of connector pins 8 are electrically insulated from each other. The housing 10 may be omitted.

Hereinafter, the components of the head base body 3 will be described.

The substrate 7 is disposed on the heat sink 1 and is rectangular in plan view. The substrate 7 has one long side 7a, the other long side 7b, one short side 7c, and the other short side 7d. The substrate 7 has an end surface 7e near the other long side 7b and a first main surface 7f on which the components of the thermal head X1 are disposed. The substrate 7 has a second main surface 7j on an opposite side to the first main surface 7f. The substrate 7 has a first corner 7g defined by the first main surface 7f and the end surface 7e of the substrate 7. The substrate 7 is made of, for example, an electrically insulating material, such as alumina ceramics, or a semiconductor material, such as single-crystal silicon.

A heat storage layer 13 is formed on the first main surface 7f of the substrate 7. The heat storage layer 13 includes a base portion 13a and a bulging portion 13b. The base portion 13a is formed on the left half of the first main surface 7f of the substrate 7. The base portion 13a is disposed near the heating elements 9 and below the protective layer 25 described below. The bulging portion 13b extends in a direction in which the plurality of heating elements 9 are arranged and has a substantially semielliptical cross section. The bulging portion 13b functions to appropriately press a recording medium P, on which printing is performed, against the protective layer 25 on the heating elements 9.

The heat storage layer 13, which is made of glass having low heat conductivity, temporarily stores a part of heat generated by the heating elements 9. Therefore, the time needed to increase the temperature of the heating elements 9 can be reduced, and the heat storage layer 13 functions to improve the thermal response characteristic of the thermal head X1. For example, the heat storage layer 13 can be formed by making a predetermined glass paste by mixing glass powder and an appropriate organic solvent, applying the glass paste to the first main surface 7f of the substrate 7 by using a known method, such as screen printing, and firing the glass paste.

A resistor layer 15 is disposed on an upper surface of the heat storage layer 13. Connection terminals 2, a ground electrode 4, a common electrode 17, individual electrodes 19, IC-connector connection electrodes 21, and IC-IC connection electrodes 26 are disposed on the resistor layer 15. The resistor layer 15 is patterned in the same shapes as the connection terminals 2, the ground electrode 4, the common electrode 17, the individual electrodes 19, the IC-connector connection electrodes 21, and the IC-IC connection electrodes 26. The resistor layer 15 includes exposed regions, which are exposed, between the common electrode 17 and the individual electrodes 19. As illustrated in FIG. 1, the exposed regions of the resistor layer 15 are arranged in a row on the bulging portion 13b of the heat storage layer 13. The exposed regions constitute the heating elements 9.

The plurality of heating elements 9, although illustrated in a simplified way in FIG. 1 for convenience of description, are arranged, for example, with a density of 100 dpi to 2400 dpi (dot per inch). The resistor layer 15 is made of a material having a comparatively high resistance, such as a TaN-based material, a TaSiO-based material, a TaSiNO-based material, a TiSiO-based material, TiSiCO-based material, or a NbSiO-based material. Therefore, when a voltage is applied to the heating elements 9, the heating elements 9 generate heat by Joule heating.

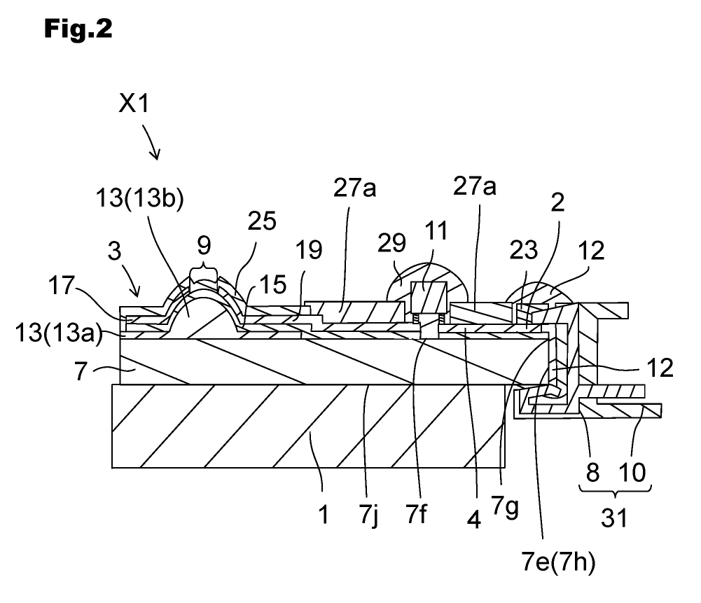

As illustrated in FIGS. 1 and 2, the connection terminals 2, the ground electrode 4, the common electrode 17, the plurality of individual electrodes 19, the IC-connector connection electrodes 21, and the IC-IC connection electrodes 26 are disposed on an upper surface of the resistor layer 15. The connection terminals 2, the ground electrode 4, the common electrode 17, the individual electrodes 19, the IC-connector connection electrodes 21, and the IC-IC connection electrodes 26 are made of an electroconductive material, such as a metal that is aluminum, gold, silver, or copper, or an alloy of these metals.

The common electrode 17 includes main wiring portions 17a and 17d, sub-wiring portions 17b, and lead portions 17c. The main wiring portion 17a extends along the one long side 7a of the substrate 7. The sub-wiring portions 17b extend respectively along the one short side 7c and the other short side 7d of the substrate 7. The lead portions 17c individually extend from the main wiring portion 17a toward the heating elements 9. The main wiring portion 17d extends along the other long side 7b of the substrate 7.

The common electrode 17 electrically connects the plurality of heating elements 9 to the connector 31. To reduce the resistance of the main wiring portion 17a, the main wiring portion 17a may be a thick electrode portion (not shown) that is thicker than the other portions of the common electrode 17. By doing so, the electric capacity of the main wiring portion 17a can be increased.

The plurality of individual electrodes 19 electrically connect the heating elements 9 to drive ICs 11. The individual electrodes 19 divide the plurality of heating elements 9 into a plurality of groups and electrically connect the heating elements 9 of each group to a corresponding one of the drive ICs 11.

The plurality of IC-connector connection electrodes 21 electrically connect the drive ICs 11 to the connector 31. The plurality of IC-connector connection electrodes 21, which are connected to the drive ICs 11, include a plurality of wires having different functions.

The ground electrode 4 is disposed so as to be surrounded by the individual electrodes 19, the IC-connector connection electrodes 21, and the main wiring portions 17d of the common electrode 17, and has a large area. The ground electrode 4 has a ground electric potential in the range of 0 to 1 V.

The connection terminals 2 are disposed adjacent to the other long side 7b of the substrate 7 so as to connect the common electrode 17, the individual electrodes 19, the IC-connector connection electrodes 21, and the ground electrode 4 to the connector 31. The connection terminals 2 correspond to the connector pins 8. When connecting the connection terminals 2 to the connector 31, the connector pins 8 and the connection terminals 2 are connected to each other in such a way that the connection terminals 2 are electrically insulated from each other. The connection terminals 2 may be connected to various electrodes or may be formed by parts of various electrodes.

The plurality of IC-IC connection electrodes 26 electrically connect the adjacent drive ICs 11. The plurality of IC-IC connection electrodes 26 correspond to the IC-connector connection electrodes 21 and transmit various signals to the adjacent drive ICs 11.

The resistor layer 15, the connection terminals 2, the common electrode 17, the individual electrodes 19, the ground electrode 4, the IC-connector connection electrodes 21, and the IC-IC connection electrodes 26 are formed by, for example, successively forming material layers of each of these on the heat storage layer 13 by using a known thin-film forming technology, such as sputtering, and then patterning the stacked body in a predetermined pattern by using a known photoetching method or the like. The connection terminals 2, the common electrode 17, the individual electrodes 19, the ground electrode 4, the IC-connector connection electrodes 21, and the IC-IC connection electrodes 26 can be simultaneously formed through the same process.

As illustrated in FIG. 1, the drive ICs 11 are disposed so as to correspond to the groups of the plurality of heating elements 9. Each of the drive ICs 11 is connected to the other end portion of each of the individual electrodes 19 and one end portion of each of the IC-connector connection electrodes 21. The drive IC 11 has a function of controlling energization of the heating elements 9. A switching member including a plurality of switching devices may be used as the drive IC 11.

Each of the drive ICs 11 is sealed with a sealing resin 29, which is made of a resin such as epoxy resin or silicone resin, in a state in which the drive IC 11 is connected to the individual electrodes 19, the IC-IC connection electrodes 26, and the IC-connector connection electrodes 21.

As illustrated in FIGS. 1 and 2, the protective layer 25, which covers the heating elements 9, a part of the common electrode 17, and parts of the individual electrodes 19, is formed on the heat storage layer 13 on the first main surface 7f of the substrate 7.

The protective layer 25 protects covered regions of the heating elements 9, the common electrode 17, and the individual electrodes 19 from corrosion due to adhesion of water or the like contained in air or wear due to contact with a recording medium on which printing is performed. The protective layer 25 may be made of SiN, SiO2, SiON, SiC, diamond-like carbon, or the like. The protective layer 25 may have only one layer or may have a stack of layers. The protective layer 25 can be formed by using a thin-film forming technology, such as sputtering, or a thick film forming technology, such as screen printing.

As illustrated in FIGS. 1 and 2, a first covering layer 27a, which partially covers the common electrode 17, the individual electrodes 19, the IC-IC connection electrodes 26, and the IC-connector connection electrodes 21, is disposed on the first main surface 7f of the substrate 7. The first covering layer 27a protects the covered regions of the common electrode 17, the individual electrodes 19, the IC-IC connection electrodes 26, and the IC-connector connection electrodes 21 from oxidation due to contact with air or from corrosion due to adhesion of water or the like contained in air.

The first covering layer 27a has openings 27a1 for exposing the individual electrodes 19, the IC-IC connection electrodes 26, and the IC-connector connection electrodes 21, which are connected to the drive ICs 11. These wires, which are exposed from the opening 27a1, are connected to the drive ICs 11. The first covering layer 27a has an opening 27a2, for exposing the connection terminals 2, near the other long side 7b of the substrate 7. The connection terminals 2, which are exposed from the opening 27a2, are electrically connected to the connector pins 8.

A second covering layer 27b extends from the first covering layer 27a onto the end surface 7e of the substrate 7. Therefore, the second covering layer 27b is continuous with the first covering layer 27a, and the first covering layer 27a and the second covering layer 27b cover the first corner 7g. The second covering layer 27b is disposed so that a part of the end surface 7e is exposed as an exposed portion 7h. Alternatively, the second covering layer 27b need not be disposed so that a part of the end surface 7e is exposed. That is, the second covering layer 27b may be disposed over the entirety of the end surface 7e.

The first covering layer 27a and the second covering layer 27b may be formed, for example, from a resin material, such as epoxy resin or polyimide resin, by using a thick film forming technology, such as screen printing. The first covering layer 27a and the second covering layer 27b may be made of different materials. In the present embodiment, an epoxy thermosetting resin is used as the first covering layer 27a and the second covering layer 27b.

The first covering layer 27a and the second covering layer 27b can be formed by screen printing. For example, the first covering layer 27a and the second covering layer 27b can be formed by applying and curing the first covering layer 27a on the first main surface 7f and then applying and curing the second covering layer 27b on the end surface 7e so as to become continuous with the first covering layer 27a. Alternatively, the first covering layer 27a and the second covering layer 27b may be simultaneously formed by applying a resin also to the end surface 7e when applying the resin to the first main surface 7f.

The connector 31 and the head base body 3 are fixed to each other via the connector pins 8, a solder 23, and the covering member 12. As illustrated in FIGS. 1 and 2, the connector pins 8 are disposed on the connection terminals 2 of the ground electrode 4 and the connection terminals 2 of the IC-connector connection electrodes 21. As illustrated in FIG. 2, the connection terminals 2 and the connector pins 8 are connected to each other via the solder 23. Without using the solder 23, the connection terminals 2 and the connector pins 8 may be electrically connected directly.

The solder 23 is, for example, a Pb-based solder. The connector pins 8 are covered by the solder 23 and thereby electrically connected to the connection terminals 2. A plating layer (not shown), which is made of Ni, Au, or Pd, may be formed between the solder 23 and the connection terminals 2.

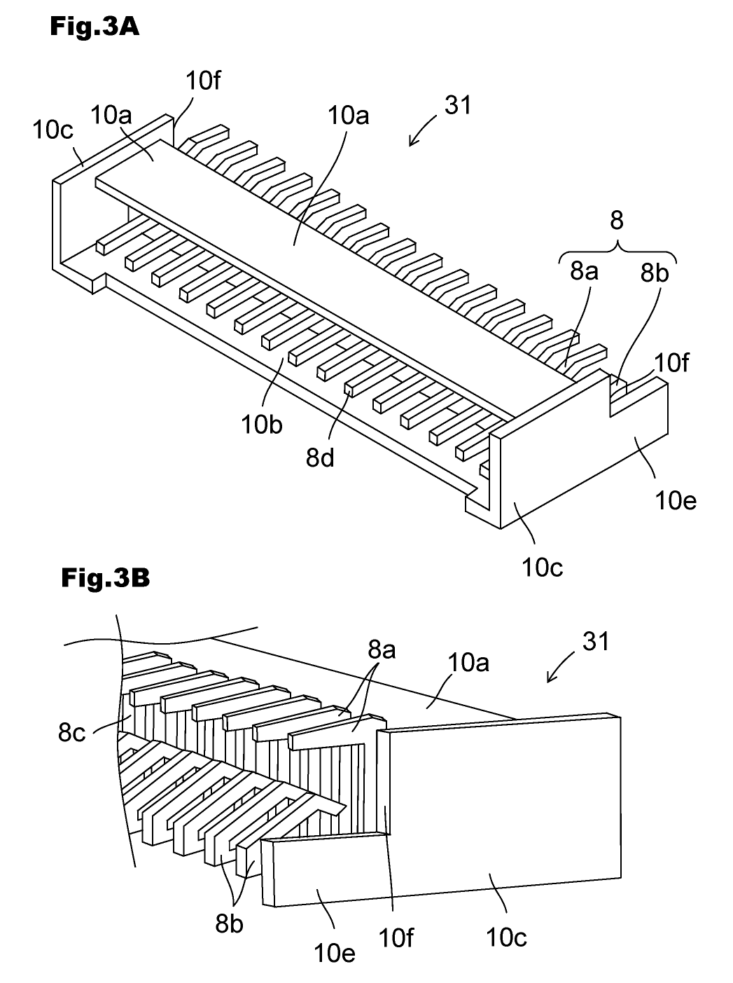

As illustrated in FIGS. 3 to 6, the connector 31 includes the plurality of connector pins 8 and the housing 10, which contains the plurality of connector pins 8. The connector 31 is joined to the substrate 7 as the connector pins 8 hold the substrate 7 therebetween.

Each of the connector pins 8 includes a first connector pin 8a, a second connector pin 8b, a link portion 8c, and a lead portion 8d. In each of the connector pins 8, the first connector pin 8a and the second connector pin 8b are connected to each other through the link portion 8c, and the lead portion 8d extends from the link portion 8c in a direction away from the substrate 7. The plurality of connector pins 8 are arranged in the main scanning direction with spaces therebetween. The connector pins 8 are separated from each other, and adjacent connector pins 8, through which different signals are transmitted, are electrically insulated from each other.

The first connector pins 8a are disposed on the connection terminals 2 (see FIG. 1). The second connector pins 8b are disposed below the substrate 7 of the head base body 3. The first connector pins 8a and the second connector pins 8b hold the substrate 3 therebetween. The link portions 8c are connected to the first connector pins 8a and the second connector pins 8b and extend in the thickness direction of the substrate 7. The lead portions 8d extend in a direction away from the head base body 3 and is joined to the housing 10. The connector 31 and the head base body 3 are electrically and mechanically joined to each other as the head base body 3 is inserted into a space between the first connector pins 8a and the second connector pins 8b.

Each of the second connector pins 8b includes a first portion 8b1 and a second portion 8b2. The first portion 8b1 extends in a direction away from the link portion 8c. The second portion 8b2 is continuous with the first portion 8b1 and extends toward a link portion 9c at an angle with respect to the first portion 8b1. The second portion 8b2 includes a contact portion 8b3, and the contact portion 8b3 is in contact with the substrate 7.

Therefore, the second connector pin 8b includes the first portion 8b1 and the second portion 8b2, which are continuously formed, and has a curved shape at a connection region between the first portion 8b1 and the second portion 8b2. Thus, when inserting the substrate 7, the second connector pin 8b and the first connector pin 8a hold the substrate 7 therebetween while the second connector pin 8b elastically deforms. As a result, the substrate 7 can be inserted into the connector 31 in a state in which the substrate 7 and the first connector pin 8 do not contact each other, so that the probability of breakage of the connection terminal 2 and the first corner 7g of the substrate 7 can be reduced.

The link portion 8c links the first connector pin 8a and the second connector pin 8b and extends in the thickness direction of the substrate 7. That is, the link portion 8c is a portion of the second connector pin 8b that extends in the thickness direction. The lead portion 8d is connected to the link portion 8c. By connecting a cable (not shown) to the lead portion 8d from the outside, a voltage is supplied to the thermal head X1.

The connector pin 8, which need to be electroconductive, may be made of a metal or an alloy. Preferably, the first connector pin 8a, the second connector pin 8b, the link portion 8c, and the lead portion 8d of each of the connector pin 8 are integrally formed. For example, the connector pin 8 can be made by punching a thin metal plate.

The housing 10 has a box shape having an opening facing away from the substrate 7 and has a function of containing the connector pins 8 in state in which the connector pins 8 are electrically insulated from each other. A socket, to which cables are connected from the outside, is inserted into the opening of the housing 10. By connecting or disconnecting the cables or the like, which are disposed outside, electricity is supplied to the head base body 3.

The housing 10 includes an upper wall 10a, a lower wall 10b, side walls 10c, a front wall 10d, and support portions 10e. The opening of the housing 10 is defined by the upper wall 10a, the lower wall 10b, the side walls 10c, and the front wall 10d. The opening is formed in the housing 10 near the lead portion 8d of the connector pins 8. The side walls 10c have positioning portions 10f near the end surface 7e. The positioning portions 10f have a function of positioning the head base body 3 that is inserted. The second covering layer 27b of the head base body 3 is abutted against the positioning portions 10f.

The support portions 10e extend from the side walls 10c toward positions below the substrate 7. The support portions 10e and the substrate 7 are disposed so as to be separated from each other. The support portions 10e extend further than the connector pin 8 from the side walls 10c toward positions below the substrate 7.

The front wall 10d has through-holes (not shown) through which the lead portions 8d extend. In a front view of the housing 10, grooves (not shown), which pass through the through-holes, are formed in the thickness direction of the housing 10. The link portions 9c are contained in the grooves, and the link portions 8c are embedded in the housing 10.

The covering member 12 is disposed so that the connection terminals 2 and the first connector pins 8a are not exposed to the outside. The covering member 12 seals the connection terminals 2 and the first connector pins 8a. The covering member 12 joins the substrate 7 and the connector 31 and reinforces the electrical and mechanical connection between the connection terminals 2 and the first connector pins 8a.

The covering member 12 may be made of, for example, an epoxy thermosetting resin, a thermosoftening resin, a UV curable resin, or a visible-light curable resin. Preferably, the covering member 12 is made of a material having higher hardness than the first covering layer 27a and the second covering layer 27b, because the covering member 12 is used to join the substrate 7 and the connector 31. In the present embodiment, an epoxy thermosetting resin is used as the covering member 12.

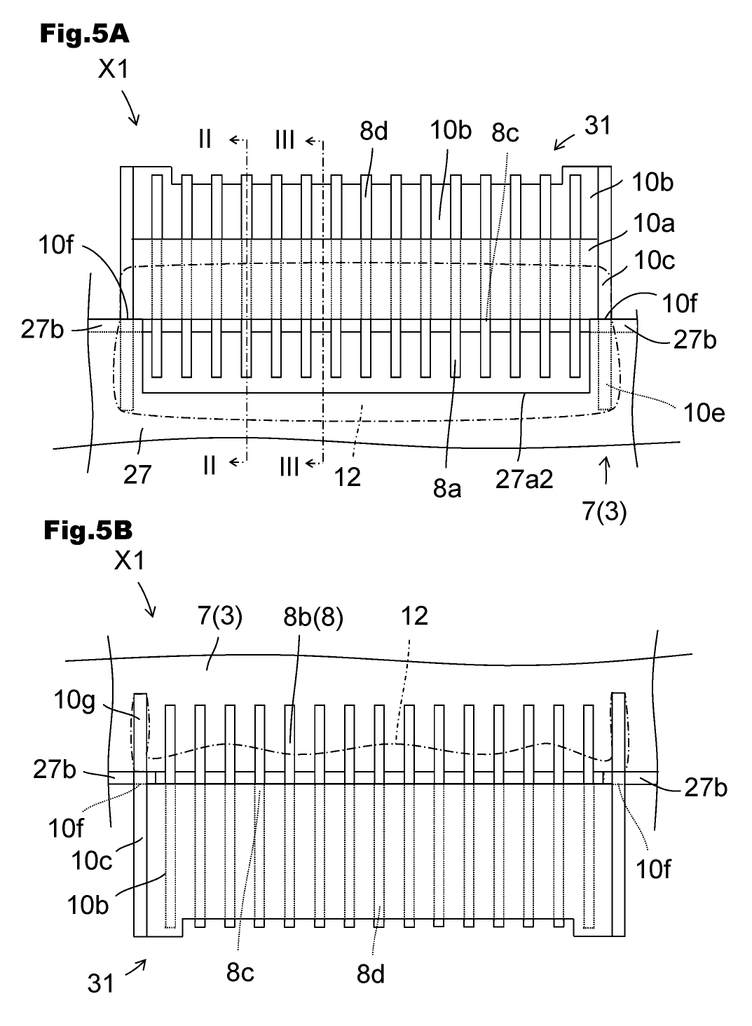

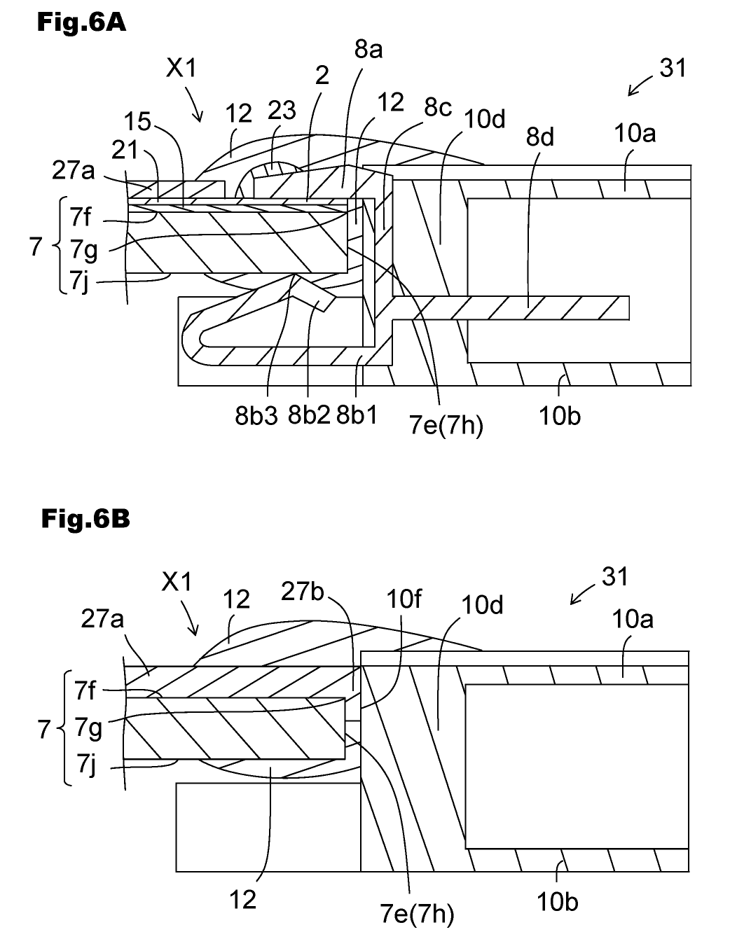

As illustrated in FIGS. 5 and 6, the covering member 12 is disposed on the first connector pins 8a and on the second connector pins 8b. A part of the covering member 12 that is disposed on the first connector pins 8a is also disposed on the upper wall 10a and the side walls 10c of the housing 10 and on the first covering layer 27a.

A part of the covering member 12 that is disposed on the second connector pin 8b is also disposed on the support portions 10e and the side walls 10c. The part of the covering member 12 disposed on the second connector pin 8b is disposed at both end portions and a central portion in the main scanning direction so as to protrude from the housing 10. Thus, the housing 10 is strongly connected to the substrate 7 against an external force in the main scanning direction.

The covering member 12 is disposed so as to completely cover the first connector pins 8a. The second connector pins 8b are disposed so as to cover the contact portions 8b3, and parts of the first portions 8b1 and the second portions 8b2 of the second connector pins 8b are exposed.

The covering member 12 is disposed also between the front wall 10d of the housing 10 and the end surface 7e of the substrate 7. The second covering layer 27b is disposed only a part of the end surface 7e near a main surface 7a. That is, a part of the end surface 7e includes the exposed portion 7h, which is exposed from the second covering layer 27b.

The substrate 7 is inserted into a space between the first connector pins 8a and the second connector pins 8b of the connector 31, and the side surface 7e of the substrate 7 is abutted against the positioning portions 10f of the side walls 10c of the housing 10. Therefore, when the side surface 7e of the substrate 7 contacts the positioning portions 10f of the housing 10, breakage may occur.

To prevent this, the thermal head X1 includes the second covering layer 27b, which extends from the first covering layer 27a onto the end surface 7e of the substrate 7, and the positioning portions 10f of the housing 10 are in contact with the second covering layer 27b. Therefore, when the substrate 7 is inserted into the housing 10, the substrate 7 contacts the second covering layer 27b. As a result, the second covering layer 27b absorbs impact when the substrate is abutted against the housing 10, and the probability of breakage of the side surface 7e of the substrate 7 can be reduced.

Because the substrate 7 is abutted against the housing 10 so that the second covering layer 27b is in contact with the positioning portions 10f of the housing 10, the head base body 3 is not abutted against the link portions 8c of the connector pins 8. Therefore, the probability of the connector pins 8 becoming, for example, bent and broken can be reduced.

The housing 10 has a box shape having an opening facing away from the substrate 7. The housing includes the front wall 10d, which is disposed adjacent to the substrate 7, and the side walls 10c, which are located on both sides of the front wall 10d in the main scanning direction, and the side walls 10c are in contact with the second covering layer 27b.

Therefore, the connector 31 is abutted against the substrate 7 at both end portions in the main scanning direction. As a result, in plan view, the probability of the connector 31 becoming inclined relative to the substrate 7 can be reduced, and the reliability of electrical connection between the head base body 3 and the connector 31 can be increased.

The substrate 7 has the first corner 7g, which is defined by the first main surface 7f and the end surface 7e. The first corner 7g is covered by the first covering layer 27a and the second covering layer 27b. That is, the first corner 7g is covered by the first covering layer 27a and the second covering layer 27b so as not to be exposed. Thus, the first corner 7g, which tends to break easily, can be reinforced by the first covering layer 27a and the second covering layer 27b, and the probability of the connector 31 contacting the first corner 7g can be reduced. As a result, the probability of chipping of the first corner 7g can be reduced.

If the second covering layer 27b were disposed over the entire area of the end surface 7e of the substrate 7, a gap, into which the covering member 12 can flow, would not be formed between the second covering layer 27b and the housing 10.

To prevent this, the end surface 7e of the substrate 7 has the exposed portion 7h, which is exposed from the second covering layer 27b; and the covering member 12 is disposed between the connector 31 and the exposed portion 7h and joins the connector 31 and the exposed portion 7h. Thus, the covering member 12, which is disposed between the connector 31 and the exposed portion 7h, can join not the connector 31 and the second covering layer 27b but the connector 31 and the substrate 7. Therefore, the joint strength of the connector 31 and the substrate 7 can be increased.

Because the housing 10 is in contact with the second covering layer 27b on the end surface 7e, when fitting the connector 31 onto the substrate 7, the connector 31 can be fitted onto the substrate 7 easily by only abutting the housing 10 against the second covering layer 27b. As a result, the connector 31 and the substrate 7 can be connected to each other through a simple process.

The surface roughness of the exposed portion 7e is greater than the surface roughness of the second covering layer 27b. Thus, when the covering member 12 is applied to the exposed portion 7h, an anchoring effect is produced and the covering member 12 flows into the exposed portion 7h. As a result, the contact area between the covering member 12 and the exposed portion 7h is increased, and the joint strength of the connector 31 and the substrate 7 can be increased.

That is, the exposed portion 7h has recesses and protrusions on the surface thereof, and the covering member 12 flows into the recesses of the exposed portion 7h. Therefore, the covering member 12 contacts the surfaces of the recesses of the exposed portion 7h, and the contact area between the covering member 12 and the exposed portion 7h is increased. As a result, the joint strength between the connector 31 and the substrate 7 can be increased.

Because the surface roughness of the second covering layer 27b is smaller than the surface roughness of the exposed portion 7e, the probability of breakage of the housing 10 when fitting the connector 31 onto the substrate 7 can be further reduced.

The arithmetic-average surface roughness (Ra) of the exposed portion 7h may be, for example, in the range of 7.5 to 8.5. The arithmetic-average surface roughness (Ra) of the second covering layer 27b may be, for example, in the range of 5.5 to 6.5. The surface roughness can be measured by using a contact or non-contact profilometer.

End portions of the second covering layer 27b are covered by the covering member 12. Thus, when the second covering layer 27b contacts the housing 12 and the end portions of the second covering layer 27b are peeled off, the covering member 12 can hold the end portions of the second covering layer 27b. As a result, the probability of peeling-off of the second covering layer 27b can be reduced.

In the thermal head X2, the thickness of the second covering layer 27b disposed on the end surface 7e is smaller than the thickness of the first covering layer 27a disposed on the first main surface 7f. Therefore, the joint strength between the connector 31 and the substrate 7 can be increased while reliably sealing various electrodes with the first covering layer 27a disposed on the first main surface 7f.

That is, because the thickness of the second covering layer 27b disposed on the end surface 7e is smaller than the thickness of the first covering layer 27a disposed on the first main surface 7f, the distance between the connector 31 and the exposed portion 7h can be reduced, and the covering member 12 can be disposed over the entirety of the exposed portion 7h due to capillary action. Thus, the joint strength between the connector 31 and the substrate 7 can be increased.

Moreover, because the thickness of the second covering layer 27b disposed on the end surface 7e is smaller than the thickness of the first covering layer 27a disposed on the first main surface 7f, increase in the distance between the end surface 7e and the connector 31 can be suppressed, and positioning of the connector 31 can be easily performed.

The thickness of the first covering layer 27a may be in the range of 10 to 30 μm. The thickness of the second covering layer 27b may be in the range of 5 to 20 μm. When the thickness of the second covering layer 27b is in the range of 5 to 15 μm, capillary action of the covering member 12 described below can function effectively. The length of the second covering layer 27b on the end surface 7e may be in the range of 50 to 300 μm.

The thickness of each of the first covering layer 27a and the second covering layer 27b is an average thickness. For example, the thicknesses of three portions of the first covering layer 27a directly below the substrate 7 may be measured, and the average of the thicknesses may be used as the thickness of the first covering layer 27a. The thickness of the second covering layer 27b may be measured in the same way.

In the example of the thermal head X1 described above, the thickness of the second covering layer 27b disposed on the end surface 7e is smaller than the thickness of the first covering layer 27a disposed on the first main surface 7f. However, this is not a limitation. The thickness of the first covering layer 27a may be equal to the thickness of the second covering layer 27b, or the thickness of the second covering layer 27b may be greater than the thickness of the first covering layer 27a.

Hereinafter, how the components of the thermal head X1 are joined will be described.

First, the substrate 7, on which the components of the head base body 3 have been formed, and the connector 31 are joined to each other. The substrate 7 is inserted into a space between the first connector pins 8a and the second connector pins 8b of the connector 31. At this time, the substrate 7 is inserted while pressing the second connector pins 8b so that a predetermined space is formed between the first connector pins 8a and the substrate 7, and the second covering layer 27b is abutted against the positioning portions 10f. Thus, the probability of breakage of the side surface 7e of the substrate 7 can be reduced.

Then, pressing of the second connector pins 8b is stopped, so that the second connector pins 8b elastically deforms and thereby the first connector pins 8a and the connection terminals 2 contact each other. Next, the solder 23 is applied to the first connector pins 8a by printing and is caused to reflow. Thus, the connector 31 and the substrate 7 are electrically and mechanically joined to each other.

Next, the covering member 12 is applied and dried by screen printing or by using a dispenser so as to cover the first connector pins 8a and the connection terminals 2. After the covering member 12 on the first connector pins 8a has been dried, the covering member 12 is applied by screen printing or by using a dispenser so that parts of the second connector pins 8b are exposed. When the covering member 12 is applied from the second connector pin 8b side, a part of the covering member 12 flows into a space between the connector 31 and the exposed portion 7h. Thus, the covering member 12 is disposed between the connector 31 and the exposed portion 7h. Subsequently, the covering member 12 is dried.

Next, the head base body 3, to which the covering member 12 is applied, is placed on the heat sink 1 on which double-sided tape or the like is disposed. The head base body 3 is placed in an oven and the covering member 12 is cured. The substrate 7 may be joined to the heat sink 1 after curing the covering member 12, or the covering member 12 may be applied and cured after joining the substrate 7 to the heat sink 1.

Next, a thermal printer Z1 will be described with reference to FIG. 7.

As illustrated in FIG. 7, the thermal printer Z1 according to the present embodiment includes the thermal head X1, a transport mechanism 40, a platen roller 50, a power supply 60, and a control device 70. The thermal head X1 is attached to an attachment surface 80a of an attachment member 80, which is disposed on a housing (not shown) of the thermal printer Z1. The thermal head X1 is attached to the attachment member 80 so as to extend in the main scanning direction, which is a direction perpendicular to the transport direction S of the recording medium P described below.

The transport mechanism 40 includes a drive unit (not shown) and transport rollers 43, 45, 47, and 49. The transport mechanism 40 transports a recording medium P, which is thermal paper, printing paper to which ink is transferred, or the like, in the direction of arrow S in FIG. 7 to transport the recording medium P onto the protective layer 25, which is located on the plurality of heating elements 9 of the thermal head X1. The drive unit has a function of driving the transport rollers 43, 45, 47, and 49. For example, a motor may be used as the drive unit. For example, the transport rollers 43, 45, 47, and 49 are made by covering cylindrical shafts 43a, 45a, 47a, and 49a, which are made of a meatal such as a stainless steel, with elastic members 43b, 45b, 47b, and 49b, which are made of butadiene rubber or the like. Although not shown in the figure, if the recording medium P is printing paper to which ink is transferred or the like, an ink film is transported together with the recording medium P to a space between the recording medium P and the heating elements 9 of the thermal head X1.

The platen roller 50 has a function of pressing the recording medium P against the protective film 25, which is located on the heating elements 9 of the thermal head X1. The platen roller 50 is disposed so as to extend in a direction perpendicular to the transport direction S of the recording medium P. Both end portions of the platen roller 50 are supported and fixed so that the platen roller 50 can rotate while pressing the recording medium P against the heating elements 9. For example, the platen roller 50 can be made by covering a cylindrical shaft 50a, which is made of a meatal such as a stainless steel, with an elastic member 50b, which is made of butadiene rubber or the like.

The power supply 60 has a function of supplying an electric current for causing the heating elements 9 of the thermal head X1 to generate heat as described above and supplying an electric current for driving the drive ICs 11. The control device 70 has a function of supplying control signals, for controlling operations of the drive ICs 11, to the drive ICs 11 to selectively cause the heating elements 9 of the thermal head X1 to generate heat.

As illustrated in FIG. 7, the thermal printer Z1 performs predetermined printing on the recording medium P by selectively causing the heating elements 9 to generate heat by using the power supply 60 and the control device 70 while transporting the recording medium P onto the heating elements 9 by using the transport mechanism 40 and pressing the recording medium P against the heating elements 9 of the thermal head X1 by using the platen roller 50. If the recording medium P is printing paper or the like, printing on the recording medium P is performed by thermally transferring ink of an ink film (not shown), which is transported together with the recording medium P, to the recording medium P.

### Second Embodiment

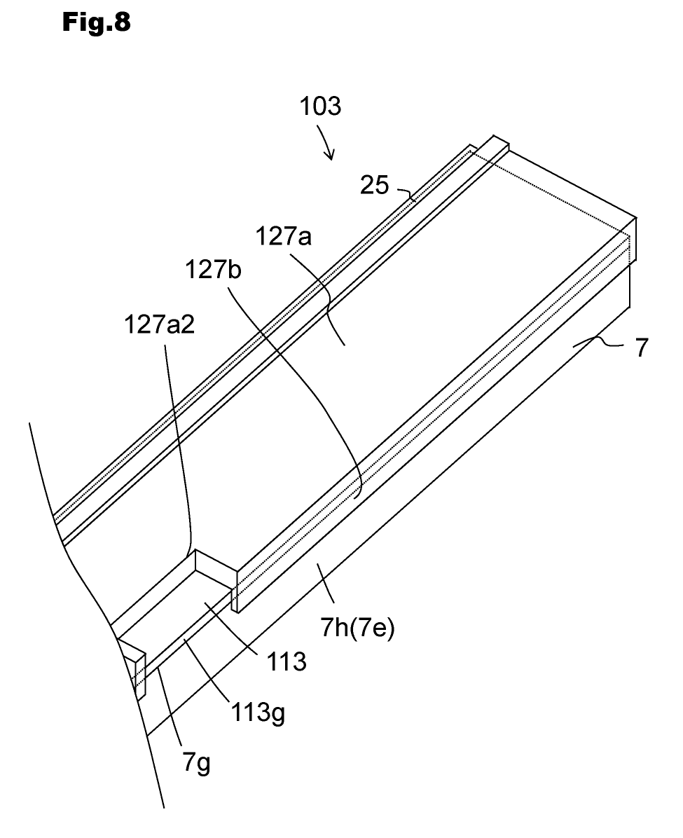

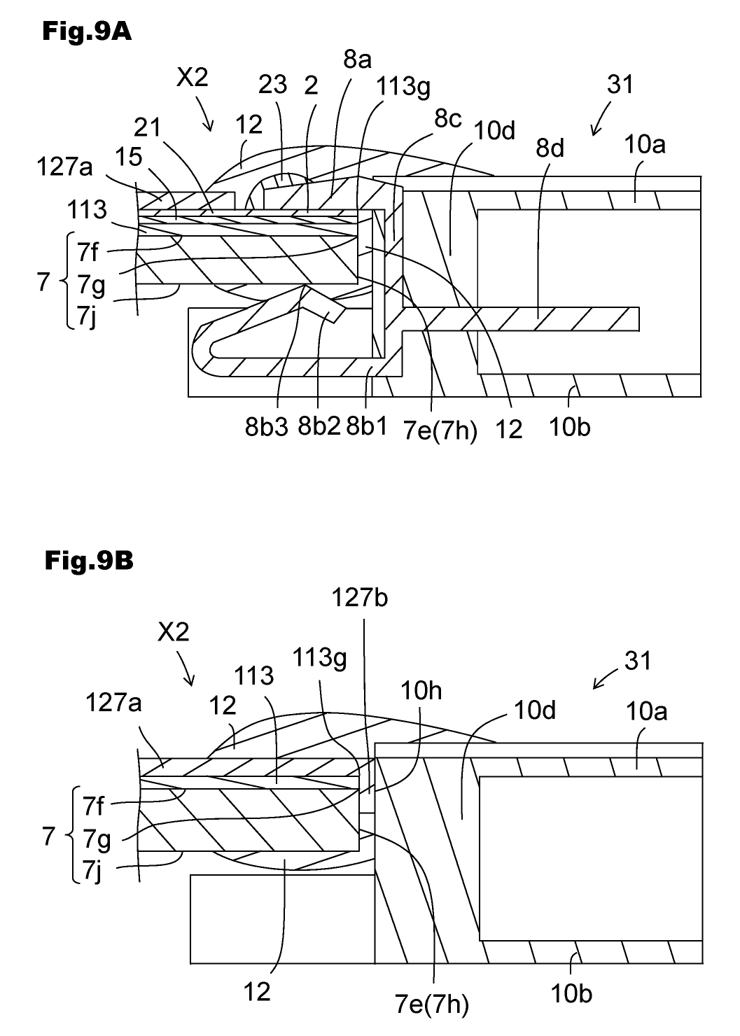

Referring to FIGS. 8 and 9, a thermal head X2 will be described. The thermal head X2 differs from the thermal head X1 in the structure of a heat storage layer 113. Hereinafter, the same members will be denoted by the same numerals. In FIG. 8, the drive ICs 11 and the openings 27a1 (see FIG. 1) are omitted.

In the thermal head X2, the heat storage layer 113 is disposed on the first main surface 7f of the substrate 7. The heat storage layer 113 is disposed over the entirety of the first main surface 7f. The heat storage layer 113 includes a second corner 113g on the first corner 7g. Preferably, the thickness of the heat storage layer 113 is in the range of 20 to 50 μm. In this case, deterioration of thermal response characteristic can be suppressed while maintaining heat storage capacity.

If the second corner 113g of the heat storage layer 113 contacts the housing when inserting the substrate 7 into the connector 31, breakage of the second corner 113g may occur. In particular, when the heat storage layer 113 is made of glass, if chipping of the second corner 113g occurs, a crack may develop and the heat storage layer 113 may lose heat storage function.

To prevent this, a first covering layer 127a and a second covering layer 127b are disposed so as to cover the second corner 113g, so that the second corner 113g is covered by the first covering layer 127a and the second covering layer 127b. As a result, the second corner 113g does not directly contact the positioning portion 10f of the housing 10, and the probability of the connector 31 contacting the second corner 113g can be reduced. As a result, the probability of breakage of the second corner 113g can be reduced.

Because the length of the second covering layer 127b in the thickness direction of the substrate 7 is greater than the thickness of the heat storage layer 113, the entirety of the end surface of the heat storage layer 113 is covered by the second covering layer 127b. Therefore, the heat storage layer 113 is not likely to be exposed, and the probability of the heat storage layer 113 contacting the connector 31 can be reduced. Therefore, the probability of occurrence of a crack in the heat storage layer 113 can be reduced.

Because the end surface of the heat storage layer 113 (not shown) is covered by the second covering layer 127b, heat dissipation from the end surface of the heat storage layer 113 can be suppressed. Thus, the heat storage capacity of the heat storage layer 113 can be maintained, and the thermal response characteristic of the thermal head X2 can be improved.

The length of the second covering layer 127b, which is located on the end surface 7e, need not be greater than the thickness of the heat storage layer 113. Also in this case, the second corner 113g is covered by the first covering layer 127a and the second covering layer 127b, so that the probability of breakage of the second corner 113g can be reduced.

### Third Embodiment

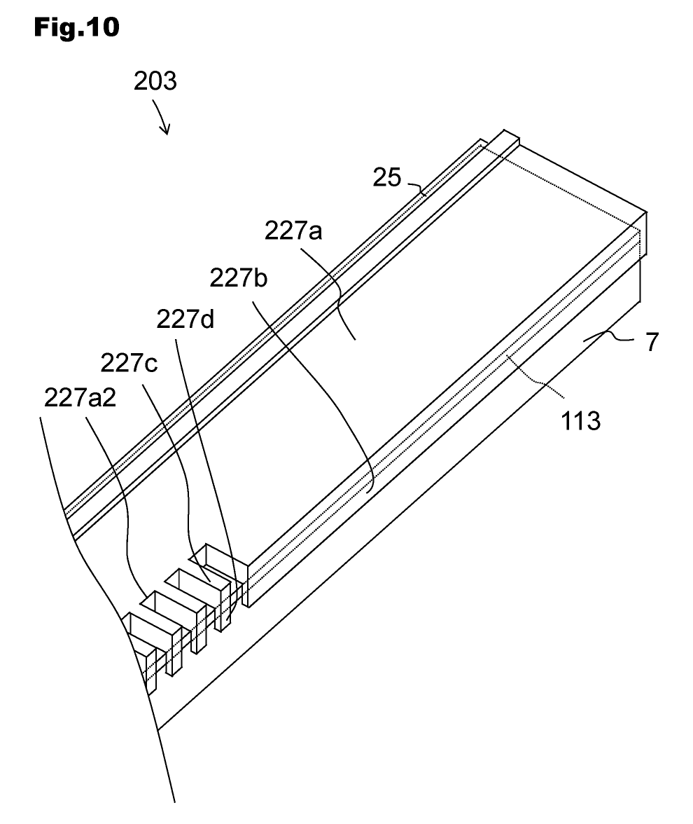

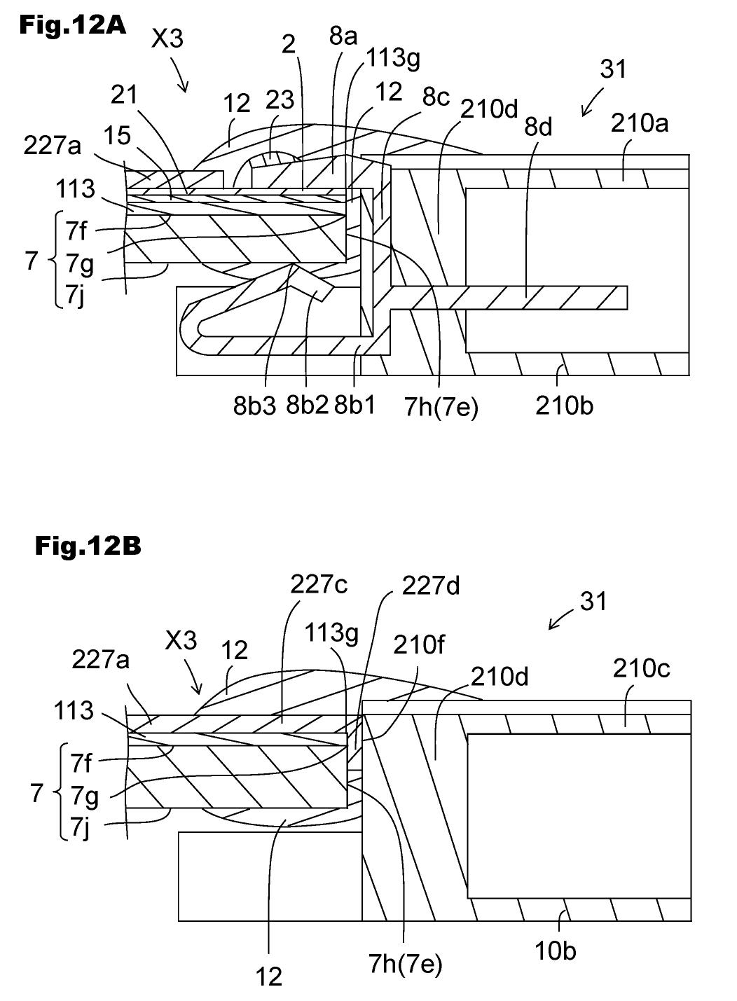

Referring to FIGS. 10 to 12, a thermal head X3 will be described. The thermal head X3 differs from the thermal head X2 in the structures of a first covering layer 227a, a second covering layer 227b, and a connector 231. In other respects, the thermal head X3 is the same as the thermal head X2. In FIG. 10, the drive ICs 11 and the openings 27a1 (see FIG. 1) are omitted.

The first covering layer 227a has the openings 27a1 and openings 227a2, is disposed on the first main surface 7f, and has the same structure as the first covering layer 127a of the thermal head x2. The second covering layer 227b extends from the first covering layer 227a onto the end surface 7e and has the same structure as the second covering layer 127b of the thermal head X2.

The first covering layer 227a is disposed on the first main surface 7f of the substrate 7 and includes first extension portions 227c, which extend from the openings 227a2 toward spaces between the plurality of first connector pins 8a. The first extension portions 227c extend to positions near the end surface 7e of the substrate 7.

The second covering layer 227b includes second extension portions 227d, which extend from the first extension portions 227c onto the end surface 7e beyond an end surface (not shown) of the heat storage layer 113. Therefore, the second extension portions 227d are formed so as to be continuous with the first extension portions 227c. The second extension portions 227d are disposed only on parts of the end surface 7e near the first main surface 7f so that a part of the end surface 7e is exposed.

The thermal head X3 includes the first extension portions 227c, which extend toward spaces between the plurality of connector pins 8. Therefore, even if a large amount of the solder 23 is applied to the first connector pins 8, it is possible to reduce the probability of occurrence of short circuit due to solder bridging, which may occur if the flow of the solder 23 is blocked by the first extension portions 227c.

The first extension portions 227c and the second extension portions 227d are formed so as to be continuous with each other. Thus, the second corner 113g can be integrally covered by the first extension portions 227c and the second extension portions 227d, and the probability of chipping of the second corner 113g can be further reduced.

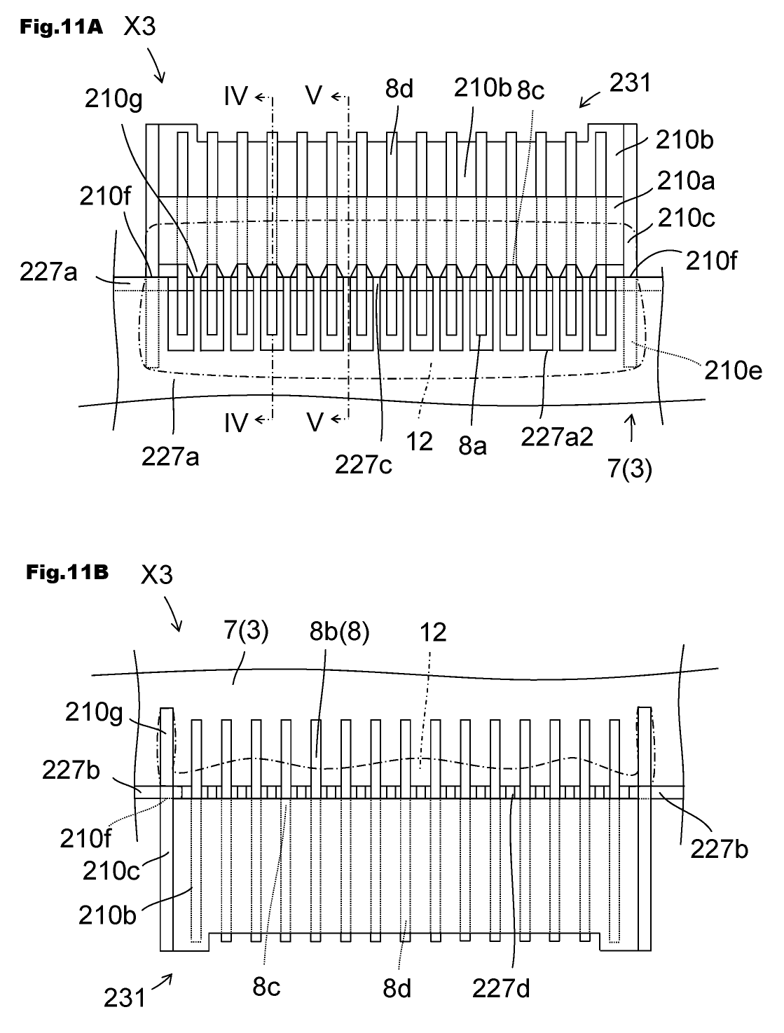

As illustrated in FIG. 11, a housing 210 includes an upper wall 210a, a lower wall 210b, side walls 210c, a front wall 210d, support portions 210e, positioning portions 210f, and protrusions 210g. Descriptions of the lower wall 210b, the side walls 210c, the front wall 210d, the support portions 210e, and the positioning portions 210f, which have the same structures as those of the housing 10, will be omitted.

The upper wall 210a is disposed so as to face the end surface 7e of the substrate 7 in a state in which the upper wall 210a is separated from the substrate 7. The upper wall 210a includes protrusions 210g, which are located between the connector pins 8 and protrude toward the substrate 7.

Therefore, when the covering member 12 is applied from the first main surface 7f side, the probability of shortage of the amount of the covering member 12 on the first main surface 7f side, which may occur if the covering member 12 flows out from a gap between the upper wall 210a and the substrate 7, can be reduced.

Because the second extension portions 228d are in contact with the protrusion 210g, when inserting a socket into the connector 231, the second extension portion 227d can absorb an external force applied to the end surface 7e. As a result, the probability of breakage of the end surface 7e can be reduced.

In the above example, the first extension portions 227c are disposed in every space between adjacent first connector pins 8a. However, this is not a limitation. The first extension portions 227c may be disposed in spaces between every second pair of first connector pins 8a or in spaces between every third pair of first connector pins 8a. The second extension portion 227b may be disposed in the same way.

### Fourth Embodiment

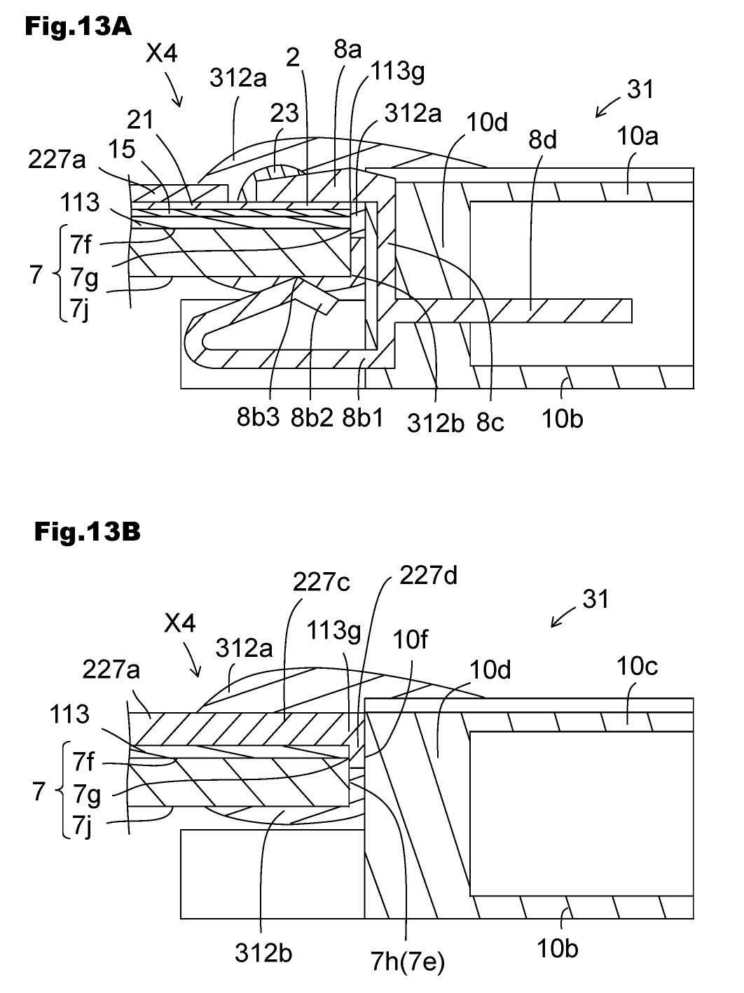

Referring to FIG. 13, a thermal head X4 according to a fourth embodiment will be described. The thermal head X4 differs from the thermal head X3 in the structure of a covering member 312. In other respects, the thermal head X4 is the same as the thermal head X3.

The covering member 312 includes a first covering member 312a and a second covering member 312b. The first covering member 312a is disposed on the first main surface 7f side. The second covering member 312b is disposed on the second main surface 7j side of the substrate 7. The hardness of the second covering member 312b is lower than that of the first covering member 312a.

The first covering member 312a may be made of, for example, an epoxy thermosetting resin. Preferably, the Shore hardness of the first covering member 312a is in the range of D80 to 100. Preferably, the thermal expansion coefficient of the first covering member 312a is in the range of 10 to 20 ppm at room temperature.

The second covering member 312b may be made of, for example, an epoxy thermosetting resin. Preferably, the Shore hardness of the second covering member 312b is in the range of D60 to 80. Preferably, the thermal expansion coefficient of the second covering member 312b is in the range of 60 to 100 ppm at room temperature.

The hardnesses of the first covering member 312a and the second covering member 312b can be measured, for example, by using a durometer (type D) compliant with JIS K 6253. For example, the hardnesses of any three portions of the first covering member 312a may be measured by using a durometer, and the average of the hardnesses may be used as the hardness of the first covering member 312a. The hardness of the second covering member 312b may be measured in the same way. The hardness may be measured by using a Shore scleroscope or the like, instead of a durometer.

The thermal head X4 has a structure in which the exposed portion 7e and the connector 31 are joined by the second covering member 312b. Thus, a portion adjacent to the first main surface 7f side, in which the first connector pins 8a are disposed, can be securely fixed in place by using the first covering member 312a; and a portion adjacent to the second main surface 7j can be fixed in place by using the second covering member 312b while absorbing a stress.

Thus, even when an external force is applied to the connector 31 due to insertion and extraction of a socket, the second covering member 312b can absorb the stress, and the probability of breakage of the covering member 312 can be reduced.

### Fifth Embodiment

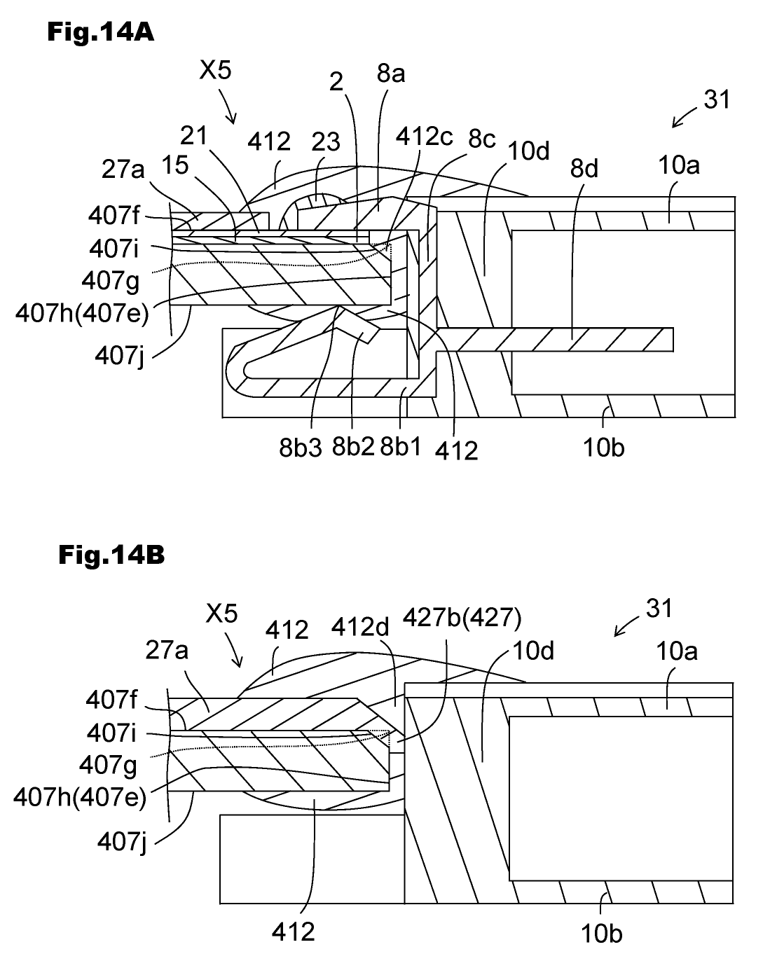

Referring to FIG. 14, a thermal head X5 according to a fifth embodiment will be described. The thermal head X5 differs from the thermal head X4 in the structures of a substrate 407, a first covering layer 427a, a second covering layer 427b, and a covering member 412. In other respects, the thermal head X5 is the same as the thermal head X4.

The substrate 407 has a first main surface 407f, an end surface 407e, and an inclined portion 407i. The end surface 407e is disposed adjacent to the first main surface 407f. The inclined portion 407i is formed by chamfering a first corner 407g, which is formed by the first main surface 407f and the end surface 407e. Chamfering may be performed by using a known method and may be flat chamfering or round chamfering.

The first covering layer 427a is disposed on the first main surface 407f of the substrate 407. The second covering layer 427b extends from the first covering layer 427a to the end surface 407e of the substrate 407. Therefore, the second covering layer 427b is disposed on the inclined portion 407i and the end surface 407e. As a result, the inclined portion 407i is covered by the first covering layer 427a and the second covering layer 427b.

The second covering layer 427b is disposed on the inclined portion 407i, and the covering member 412 is disposed on the second covering layer 427b on the inclined portion 407i. Therefore, a portion 412d of the covering member 412 is disposed on the second covering layer 427b on the inclined portion 407i.

Thus, the portion 412d of the covering member 412 is disposed in the gap between the connector 31 and the substrate 407. As a result, even when the covering member 412 contacts the recording medium P (see FIG. 7), the probability of peeling-off of the covering member 412 can be reduced, because the joint strength of the covering member 412 and the substrate 407 and the connector 31 is large.

The present invention is not limited to the embodiments described above, which can be modified in various ways within the spirit and scope of the present invention. For example, the thermal printer Z1 includes the thermal head X1 according to the first embodiment. This is not a limitation, and the thermal heads X2 to X5 may be used for the thermal printer Z1. The thermal heads X1 to X5 according to the embodiments may be used in combination.

In the thermal heads X1 to X5, the connector 31 is disposed at a central part in the arrangement direction. However, the connector 31 may be disposed at each of two ends of the substrate 7 in the main scanning direction.

Without forming the bulging portion 13b in the heat storage layer 13, the heating elements 9 of the resistor layer 15 may be disposed on the base portion 13a of the heat storage layer 13.

The heating elements 9 may be formed by forming the common electrode 17 and the individual electrodes 19 on the heat storage layer 13 and by forming the resistor layer 15 only in regions between the common electrode 17 and the individual electrodes 19.

In the above examples, the thermal heads are thin-film heads in which the resistor layer 15 is formed as a thin film and the heating elements 9 are thin. However, this is not a limitation. For example, the present invention may be used for a thick-film head in which thick heating elements 9 are formed by patterning various electrodes and then forming the resistor layer 15 by using a thick-film forming technology. The present technology may be used for an end-surface head in which the heating elements 9 are formed on the end surface 7e of the substrate 7. In the above examples, the end surface 7e is perpendicular to the first main surface 7f. However, the end surface 7e may be a curved surface, or a surface that is partially inclined with respect to the first main surface 7f.

The covering member 12 may be made of a material that is the same as the sealing resin 29, which covers the drive ICs 11. In this case, the sealing resin 29 and the covering member 12 may be simultaneously formed by printing a region in which the covering member 12 is formed when printing the sealing resin 29.

### REFERENCE SIGNS LIST

X1 to X5 thermal head
Z1 thermal printer
1 heat sink
2 connection terminal
3 head base body
7 substrate
7e end surface
7f first main surface
7g first corner
7h exposed portion
7i inclined portion
7j second main surface
8 connector pins
9 heating elements
10 housing
12 covering member
23 solder
25 protective layer
27a first covering layer
27b second covering layer
29 sealing resin
31 connector

1. A thermal head comprising:
a substrate having a first main surface and an end surface adjacent to the first main surface;
heating elements disposed on the first main surface or on the end surface;
electrodes disposed on the first main surface and electrically connected to the heating elements;
a first covering layer disposed on parts of the electrodes;
a connector adjacent to the end surface, comprising connector pins disposed on the electrodes and a housing containing the connector pins;
a covering member covering the connector pins and the electrodes; and
a second covering layer at least disposed between the first covering layer and an end of the first main surface near the end surface, and
wherein the housing is in contact with the second covering layer.

2. The thermal head according to claim 1,
wherein the housing has a box shape having an opening facing away from the substrate and comprises a front wall adjacent to the substrate and side walls located on both sides of the front wall in a main scanning direction, and
wherein the side walls are in contact with the second covering layer.

3. The thermal head according to claim 1,
wherein the substrate comprises a first corner that is formed by the first main surface and the end surface, and
wherein the first corner is covered by the first covering layer and the second covering layer.

4. The thermal head according to claim 3, further comprising:
a heat storage layer disposed on the first main surface,
wherein the heat storage layer comprises a second corner located on the first corner, and
wherein the second corner is covered by the first covering layer and the second covering layer.

5. The thermal head according to claim 4, wherein a length of the second covering layer in a thickness direction of the substrate is greater than a thickness of the heat storage layer.

6. The thermal head according to claim 3,
wherein the first corner comprises an inclined portion that is chamfered,
wherein the second covering layer is disposed on the inclined portion, and
wherein the covering member is disposed on the second covering layer.

7. The thermal head according to claim 1,
wherein the end surface comprises an exposed portion exposed from the second covering layer, and
wherein the covering member is disposed between the connector and the exposed portion and joins the connector and the exposed portion.

8. The thermal head according to claim 7, wherein a surface roughness of the exposed portion is greater than a surface roughness of the second covering layer.

9. The thermal head according to claim 7,
wherein the substrate has a second main surface opposite to the first main surface,
wherein the covering member comprises a first covering member disposed on the first main surface and a second covering member disposed on the second main surface, and
wherein the second covering member has a hardness lower than that of the first covering member and joins the exposed portion and the connector.

10. The thermal head according to claim 1, wherein an end portion of the second covering layer is covered by the covering member.

11. The thermal head according to claim 1, wherein a thickness of the second covering layer is smaller than a thickness of the first covering layer.

12. The thermal head according to claim 1, wherein the first covering layer further comprises first extension portions, each of the first extension portions disposed between one of the connector pins and another one of the connector pins.

13. The thermal head according to claim 12, wherein the second covering layer further comprises second extension portions extending from the first extension portions onto the end surface.

14. The thermal head according to claim 13,
wherein the housing comprises an upper wall disposed on the connector pins,
wherein the upper wall comprises protrusions located between the connector pins that protrude toward the substrate in a plan view, and
wherein the second extension portions are in contact with the protrusions.

15. A thermal printer comprising:
the thermal head according to claim 1;
a transport mechanism that transports a recording medium onto the heating elements; and
a platen roller that presses the recording medium against the heating elements.

16. The thermal head according to claim 1,
wherein the second covering layer extends from the first covering layer onto the end surface.
